(19) United States
(12) Patent Application Publication
(10) Pub. No.: US 2022/0108052 A1
(43) Pub. Date: Apr. 7, 2022

(54) VERIFICATION DEVICE, VERIFICATION METHOD, AND COMPUTER-READABLE RECORDING MEDIUM

(71) Applicant: MITSUBISHI ELECTRIC CORPORATION, Tokyo (JP)

(72) Inventors: Takuma ORIMOTO, Tokyo (JP); Michiyasu HIRAMATSU, Tokyo (JP); Hiroki ITO, Tokyo (JP)

(73) Assignee: MITSUBISHI ELECTRIC CORPORATION, Tokyo (JP)

(21) Appl. No.: 17/554,546

(22) Filed: Dec. 17, 2021

Related U.S. Application Data
(63) Continuation of application No. PCT/JP2019/033108, filed on Aug. 23, 2019.

(51) Int. Cl. G06F 30/20

(52) U.S. Cl. CPC G06F 30/20

(57) ABSTRACT

A verification device (2) includes: a simulation performing unit (4) to perform simulation; a delay detection unit (5) to detect, as a delay simulation, a simulation being performed by the simulation performing unit (4) and not having real-time responsiveness; a past data accumulation unit (7) containing an accumulation of past data related to a simulation performed by the simulation performing unit (4) in the past; and a past data search unit (6) to search for past data corresponding to a delay simulation when the delay detection unit (5) detects the delay simulation.

### CROSS REFERENCE TO RELATED APPLICATIONS

This application is a Continuation of PCI International Application No. PCT/JP2019/033108, filed on Aug. 23, 2019, which is hereby expressly incorporated. by reference into the present application.

### TECHNICAL FIELD

The present invention relates to a verification device, a verification method, and a verification program.

### BACKGROUND ART

In development of an electronic control instrument such as an automobile and an air conditioner, it is necessary to verify whether a device equipped with the electronic control instrument operates correctly. However, preparation of an apparatus such as a motor which is to be controlled by the electronic control instrument, and/or setting and so on of an environmental condition for operating the electronic control instrument, is sometimes difficult. Verification through a linkage with a simulation may solve this difficulty.

When a simulation is employed as an alternative to a correspondent device of the electronic control instrument to be verified, and to an environment in which the electronic control instrument to be verified is operated, real-time responsiveness of the simulation becomes an issue.

Patent Literature 1 describes a system which uses dedicated Hardware (HW) referred to as Hardware in the loop simulator (HILS) and which executes simultaneously a simulation having real-time responsiveness due to a small amount of calculation and a simulation sometimes having no real-time responsiveness due to a large amount of calculation, so that simulation results are outputted while real-time responsiveness is ensured.

### CITATION LIST

### Patent Literature

Patent Literature 1: JP 2008-165544 A

### SUMMARY OF INVENTION

### Technical Problem

However, the technique of Patent Literature 1 has a problem that,

a simulation sometimes having no real-time responsiveness due to a small amount of calculation is a simulation that uses a proper simulation model, and

in a case where the real-time responsiveness cannot be ensured with using the proper simulation model, a result of a simulation that uses a simplified simulation model of the proper simulation model is returned, and accordingly a simulation result that cannot happen when the proper simulation model is used may be sometimes outputted.

An objective of the present invention is, even in a case where real-time responsiveness cannot be ensured by a simulation sometimes having no real-time responsiveness due to a large amount of calculation, to output a simulation result that can happen when a proper simulation model is used, while ensuring real-time responsiveness with respect to an electronic control instrument to be verified.

### Solution to Problem

A verification device of the present invention includes:

a simulation performing unit to perform a simulation;

a delay detection unit to detect, as a delay simulation, a simulation being performed by the simulation performing unit and not having real-time responsiveness;

a past data accumulation unit containing an accumulation of past data related to a simulation performed by the simulation performing unit in a past; and

a past data search unit to search for past data corresponding to a delay simulation when the delay detection unit detects the delay simulation.

### Advantageous Effects of Invention

According to the present invention, a simulation result that is included in past data accumulated in a past data accumulation unit and that is obtained with a proper simulation model is used, so that even in a case where real-time responsiveness cannot be ensured by the proper simulation model, it is possible to output a simulation result that can happen when the proper simulation model is used, while ensuring simulation real-time responsiveness.

### BRIEF DESCRIPTION OF DRAWINGS

FIG. 1 is a configuration diagram of a verification device 2 according to Embodiment 1.

FIG. 2 is a hardware configuration diagram of the verification device 2 according to Embodiment 1.

FIG. 3 is a time chart corresponding to a simulation of a simulation performing unit 4 according to Embodiment 1.

FIG. 4 is a time chart corresponding to a simulation of the simulation performing unit 4 according to Embodiment 1.

FIG. 5 is a flowchart illustrating operations of the verification device 2 according to Embodiment 1.

### DESCRIPTION OF EMBODIMENTS

### Embodiment 1

The present embodiment will be described in detail with referring to drawings.

Description of Configurations

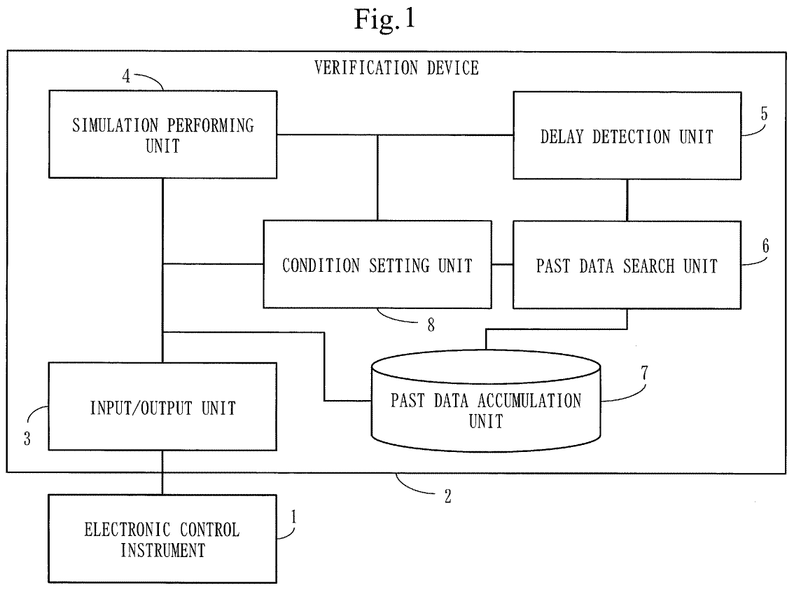

FIG. 1 is a diagram illustrating a basic configuration of a verification device 2 according to the present embodiment.

An electronic control instrument 1 is an electronic control instrument to be verified by the verification device 2. The electronic control instrument 1 inputs/outputs a signal to control a machine such as a motor which is to be controlled.

As illustrated in FIG. 1, the verification device 2 is provided with an input/output unit 3, a simulation performing unit 4, a delay detection unit 5, a past data search unit 6, a past data accumulation unit 7, and a condition setting unit 8.

The verification device 2

is connected to the electronic control instrument 1,

is a device that verifies a function and/or a performance and so on of the electronic control instrument 1, and

can simulate a status, behavior, and so on of a motor or the like which is to be controlled by the electronic control instrument 1.

The electronic control instrument 1 and the verification device 2 may be connected by any manner.

The input/output unit 3 can fetch a signal outputted by the electronic control instrument 1, and can output to the electronic control instrument 1 a signal such as an analog sensor signal and a digital contact signal, which is necessary for operations of the electronic control instrument 1.

The input/output unit 3 can output a physical status or the like received from the simulation performing unit 4 to the electronic control instrument 1 in the form of a signal.

The input/output unit 3 communicates with the electronic control instrument 1.

The simulation performing unit 4

simulates a device to he controlled by the electronic control instrument 1, an operation environment of the electronic control instrument 1, and the like, on the basis of the signal received from the input/output unit 3, a calculation formula and/or a model being preset in advance, and the like, to thereby obtain output data to be outputted to the electronic control instrument 1, and

sends the output data to the input/output unit 3.

The output data includes a physical status, as a specific example.

The simulation performing unit 4

may be able to execute a simulation based on a plurality of simulation models, and

may judge which simulation model to use on the basis of input data received from the input/output unit 3.

The simulation model adopted by the simulation performing unit 4 will be referred to as a proper simulation model.

The delay detection unit 5

monitors progress of a simulation being performed by the simulation performing unit 4, and

judges whether the simulation will be completed or not within a predetermined time limit since start of the simulation.

This predetermined time limit will be referred to as “request response time” hereinafter.

A user may be able to set the request response time. The delay detection unit 5 may change the request response time by an arbitrary method while the simulation performing unit 4 is performing the simulation.

The delay detection unit 5

judges that the simulation does not have real-time responsiveness, in cases where a simulation being performed by the simulation performing unit 4 is not likely to he completed within the request response time, and

judges that the simulation has real-time responsiveness otherwise.

The cases where the simulation is not likely to be completed within the request response time include a case where the simulation is not actually completed within the request response time, and a case where there is a possibility that the simulation is not actually completed within the request response time.

The past data search unit 6 searches for past data accumulated in the past data accumulation unit 7 and corresponding to the simulation being performed by the simulation performing unit 4.

The past data signifies data accumulated in the past data search unit 6.

The past data accumulation unit 7

contains an accumulation of past data related to a simulation performed by the simulation performing unit 4 in the past, and

contains, in a specific example, an accumulation of data corresponding to: a combination of input data in the simulation performed by the simulation performing unit 4 in the past and a simulation result corresponding to the input data; a simulation result of data of a sensor or the like to be controlled by the electronic control instrument 1; and input data when the electronic control instrument 1 is operated in a real environment without relying on a simulation by the simulation performing unit 4.

The past data stored in the past data accumulation unit 7 typically includes: input data (a signal outputted by the electronic control instrument 1, data of a peripheral environment of the verification device 2, and the like) employed by the simulation performing unit 4; output data (a signal to be inputted to the electronic control instrument 1 and data of the peripheral environment of the verification device 2) of the simulation performing unit 4; and internal status data of the simulation performing unit 4.

An internal status is, in a specific example, a status determined by a variable employed by the simulation, and includes a calculation condition of the simulation. Data expressing the internal status is referred to as internal status data.

In the past data accumulation unit 7, the past data is accumulated in a format that shows whether or not the past data corresponds to a simulation having real-time responsiveness.

Following are examples of the past data accumulated in the past data accumulation unit 7.

Data A: a result of a simulation performed by the simulation performing unit 4 with using data received from the electronic control instrument 1.

Data B: a result of a simulation performed by the simulation performing unit 4 in a real-time manner or a non-real-time manner as a simulator that simulates the operations of the electronic control instrument 1 is connected to the verification device 2 and the simulator supplies input data of an operation series to the verification device 2.

Data C: an operation log of the electronic control instrument 1 when the electronic control instrument 1 is operated in the proper operation environment, and/or data of a monitoring device connected to the electronic control instrument 1.

Data D: a combination of input data and output data independent of the simulation of the simulation performing unit 4, the combination being a combination of input data and output data prepared by the user.

Each of the data A and the data B typically includes a calculation amount and a simulation time of when the simulation performing unit 4 has actually performed the simulation.

The data C

may include a calculation amount and a simulation time which are assumed by the user, and

may include a calculation amount and a simulation time which are estimated from a calculation amount and a simulation time, respectively, of the data A or data B being similar to the data C.

The data D is like the data C.

When the delay detection unit 5 judges that calculation will not be completed within the request response time, the condition setting unit 8 typically performs resetting of the internal status of the simulation of the simulation performing unit 4 and setting of output data to be outputted by the input/output unit 3, on the basis of the past data searched for by the past data search unit 6.

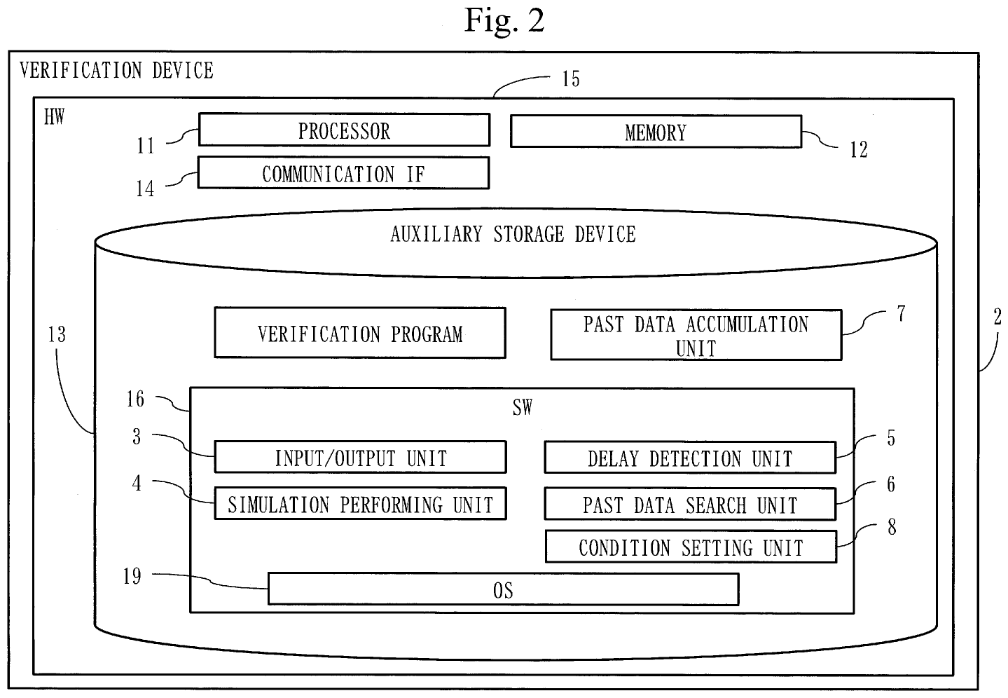

FIG. 2 illustrates a hardware (HW) and software (SW) configuration example of the verification device 2 according to the present embodiment.

The verification device 2 is formed of HW 15 illustrated in FIG. 2.

The verification device 2 is typically formed of a general purpose Personal Computer (PC).

Processes of the input/output unit 3, simulation performing unit 4, delay detection unit 5, past data search unit 6, and condition setting unit 8 are carried out as a processor 11 reads and executes a program stored in a memory 12.

The HW 15 indicates a hardware configuration of Embodiment 1 and is formed of the processor 11, the t memory 12, and an auxiliary storage device 13.

The processor 11 is a processing device that runs a verification program, an Operating System (OS), and so on. The processing device may also be referred to as an Integrated Circuit (IC). Specific examples of the processor 11 are a Central Processing Unit (CPU), a Digital Signal Processor (DSP), and a Graphics Processing Unit (GPU).

The processor 11 is connected to the memory 12, temporarily stores data necessary for computation and/or saves data, and reads and runs the program stored in the memory 12.

The verification device 2 of FIG. 2 is provided with only one processor 11, but the verification device 2 may be provided with a plurality of processors that substitute for the processor 11. The plurality of processors share program running and so on.

The memory 12 is a storage device that stores data temporarily, and functions as a main memory used as a work area of the processor 11. A specific example of the memory 12 is a Random-Access Memory (RAM) such as a Static Random-Access Memory (SRAM) and a Dynamic Random-Access Memory (DRAM). The memory 12 keeps a computation result of the processor 11.

The auxiliary storage device 13 stores the verification program, various programs run by the processor 11, SW 16, data used when running the programs, and so on. The past data accumulation unit 7 is formed of the auxiliary storage device 13. A specific example of the auxiliary storage device 13 is a Hard Disk Drive (HDD) or a Solid-State Drive (SSD). The auxiliary storage device 13 may be a portable recording medium such as a memory card, a Secure Digital (SD: registered trademark) memory card, a Compact Flash (CF), a NAND flash, a flexible disk, an optical disk, a compact disk, a Blu-ray (registered trademark) disc, and a Digital Versatile Disk (DVD).

A communication interface (IF) 14 is an interface to communicate with other apparatuses via a network, and executes part of the process of the input/output unit 3.

A specific example of the communication IF 14 is an Ethernet (registered trademark) port or a Universal Serial Bus (USB) port. The communication IF 14 may include a plurality of ports.

The SW 16 illustrates a software configuration of Embodiment 1, and its processes with the input/output unit 3, simulation performing unit 4, delay detection unit 5, past data search unit 6, and condition setting unit 8 are formed of the memory 12 and the OS 19.

An OS 19 is loaded from the auxiliary storage device 13 by the processor 11, is developed on the memory 12, and is run on the processor 11. A specific example of the OS 19 may be any software such as Linux (registered trademark) and Windows (registered trademark) that matches the processor 11.

The OS 19 and the SW 16 may be stored in the memory 12. The past data accumulation unit 7 may be formed of the memory 12.

Description of Operations

An operation procedure of the verification device 2 corresponds to a verification method. A program that implements operations of the verification device 2 corresponds to the verification program.

The verification device 2 decides to output to the electronic control instrument 1, data corresponding to a change in output signal of the electronic control instrument 1, within the request response time since a time point at which the signal change is detected, so that the electronic control instrument 1 can operate appropriately.

The request response time of the verification device 2 may differ depending on a function and/or a characteristic of the electronic control instrument 1, and so on. According to a specific example, the verification device 2 shortens the request response time when the electronic control instrument 1 is an inverter control instrument, and extends the request response time when the electronic control instrument 1 is a temperature control instrument.

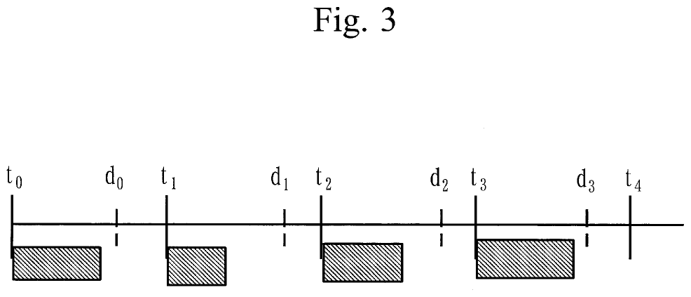

FIG. 3 is an example of a time chart corresponding to the simulation of the simulation performing unit 4, and illustrates a case where all simulations of the simulation performing unit 4 are completed within the request response time.

In FIG. 3,

tₙ (n is an integer of 0 or more, the same applies to the following) expresses a change detection time point at which the simulation performing unit 4 has detected a change in output signal of the electronic control instrument 1,

each interval from a change detection time point to a next change detection time point need not be constant,

the smaller a subscript to t, the more past the indicated time point,

a vertical bar immediately under each to corresponds to tₙ,

dₙ expresses a time point of a lapse of the request response time since an immediately preceding tₙ,

a vertical broken-line bar immediately under each dₙ corresponds to dₙ,

a rectangle extending to the right from each tₙ expresses a term during which the simulation performing unit 4 performs a simulation, and

a length of the rectangle changes depending on a condition of the simulation or the like.

When all simulations of the simulation performing unit 4 are completed within the request response time, the input/output 3 can output to the electronic control instrument 1 output data corresponding to each simulation result.

Each in may also be referred to as an input timing. As opposed to tₙ, tₙ₊₁ may be referred to as “a next input timing”. As opposed to tₙ₊₁, tₙ may he referred to as “a preceding input timing”.

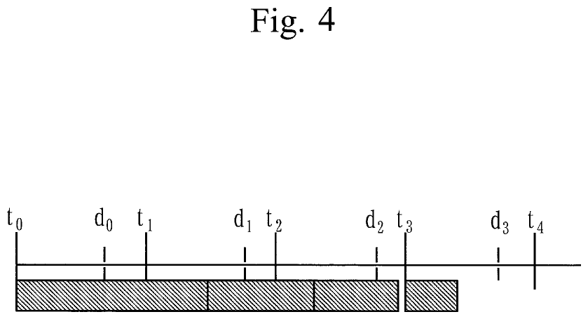

FIG. 4 is an example of a time chart corresponding to a simulation of the simulation performing unit 4, and illustrates a case where some simulations of the simulation performing unit 4 are not completed within the request response time. Explanations for FIG. 4 apply to FIG. 3.

In the case where a simulation of the simulation performing unit 4 is not completed within the request response time, the verification device 2 outputs, at a time point of a lapse of the request response time since an input timing corresponding to the simulation not completed within the request response time, output data corresponding to a past simulation result, so that an inappropriate result will not be outputted to the electronic control instrument 1. Instead of outputting the output data, the verification device 2 may prepare for outputting the output data. The past simulation result signifies a simulation result of a simulation performed by the simulation performing unit 4 in the past.

Therefore, the electronic control instrument 1 can receive appropriate data from the verification device 2.

The verification device 2 may output, before the request response time elapses, output data corresponding to a past simulation result.

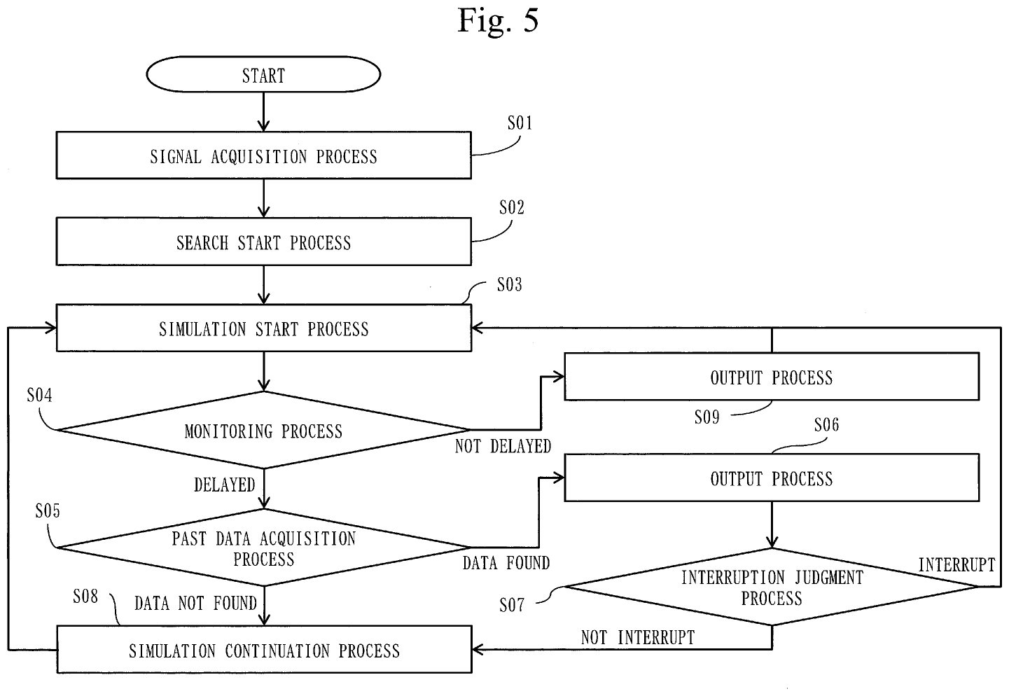

FIG. 5 is an example of a flowchart illustrating the operations of the verification device 2 according to the present embodiment.

A procedure indicated in this flowchart may be changed as necessary.

The operations of the verification device 2 will be described with referring to FIG. 5.

The verification device 2 continues processing of this flowchart until a stop operation of the verification device 2, or the like is instructed by the user.

(Step S01: Signal Acquisition Process)

The input/output unit 3

acquires a signal from the electronic control instrument 1, and

sends input data included in the acquired signal to the simulation performing unit 4.

A process of this step may be started by any trigger. In a specific example, the trigger may be a user's operation.

Typically, the input/output unit 3 continues the process of this step periodically in parallel with the following process.

(Step S02: Search Start Process)

The past data search unit 6 starts search of the past data.

The past data search unit 6 performs a process of this step regardless of whether or not the delay detection unit 5 judges that a delay occurs, in order to finish the search before the request response time elapses since the input timing.

The process to be started in this step corresponds to, out of a description on step S05, a process of the past data search unit 6 to search the past data accumulation unit 7.

The verification device 2 advances to a next step even if the past data search unit 6 has not completed the search of the past data, and

the past data search unit 6 executes the search process in parallel with a process of the next step and beyond until the search of the past data is completed.

(Step S03: Simulation Start Process)

The simulation performing unit 4 performs the simulation with using the input data received from the input/output unit 3.

(Step S04: Monitoring Process)

The delay detection unit 5

starts a process of monitoring whether the simulation of the simulation performing unit 4 is completed or not within the request response time, and

if a predetermined condition is satisfied, judges that a delay occurs, that is, judges that the simulation is not completed within the request response time.

Typically, even during execution of a process of a step after step S04, if the simulation performing unit 4 is performing a simulation, the delay detection unit 5 monitors the simulation of the simulation performing unit 4,

The delay detection unit 5 judges that a delay occurs not only when the simulation time actually overruns the request response time but also when there is a possibility that the simulation time overruns the request response time.

A case judged as a delay by the delay detection unit 5 is sometimes expressed as “the simulation is delayed”. A simulation judged as a delay by the delay detection unit 5 is sometimes expressed as a “delayed simulation”.

The delay detection unit 5

detects a simulation being performed by the simulation performing unit 4 and not having real-time responsiveness, as a delayed simulation.

That is, the delay detection unit 5 detects a simulation not likely to be completed within the request response time, as a delayed simulation.

The following four conditions are each an example of a condition by which the delay detection unit 5 judges a case as a delay, that is, a condition by which the delay detection unit 5 detects a simulation of the simulation performing unit 4 as a delayed simulation. The condition by which the delay detection unit 5 judges a case as a delay may be a combination of a plurality of conditions.

Condition A: the simulation is not completed at a time point where the request response time has elapsed.

By this condition, the delay detection unit 5 judges, as a delay, a case where a simulation is not completed at a time point of a lapse of the request response time since the simulation is started.

Condition B: at an arbitrary timing within the request response time, a progress rate corresponding to the timing is not reached.

By this condition, in a practical example, the delay detection unit 5 judges, as a delay, a case where 50% of the entire process has not been ended at a time point where 50% of the request response time has elapsed since the simulation is started.

Condition C: the input data and/or internal status coincides with or is similar to input data and/or internal state of a past case where the request response time was overrun.

By this condition, the delay detection unit 5 judges, as a delay, a case where the input data and/or internal status coincides with or is similar to the input data and/or internal state of a past case where the simulation time was overrun.

The input data and/or internal status concerning this condition may he part of the entire input data and/or part of the internal status.

The delay detection unit 5 may utilize a search result of the past data search unit 6 for determining whether the simulation time overruns the request response time or not.

Condition D: the input data and/or internal status conforms to a predetermined rule.

By this condition, in a specific example, the delay detection unit 5 judges, as a delay, a case where the input data and/or internal status conforms to the predetermined rule, such as a case where a certain variable included in the input data changes from ON to OFF.

A combination of conditions, a parameter concerning the conditions, and so on may be designated by the user of the verification device 2, or may be derived by the delay detection unit 5 with using an arbitrary learning method.

The verification device 2

advances to step S05 if the delay detection unit 5 judges a case as a delay, and

advances to step S09 otherwise.

(Step S05: Past Data Acquisition Process)

The past data search unit 6 judges whether or not the input data and/or internal status corresponding to the simulation accumulated in the past data accumulation unit 7 coincides with or is similar to the present input data and/or internal status.

The present input data and/or internal status signifies input data and/or internal status corresponding to the simulation being performed by the simulation performing unit 4.

A specific example of a method of judging, by the past data search unit 6, coincidence or similarity of the input data and/or internal status data includes

a method of making judgment from a degree of coincidence between the present input data and the past input data, and/or between the present internal status data and the present internal status data,

a method of calculating values that are weighted values of differences per item of the input data and/or internal status data, calculating a similarity degree that is a sum of the calculated values, and making judgment on the basis of the calculated similarity degree, and

a method of making judgment with using a feature amount learned from past data according to an arbitrary algorithm.

The algorithm used by the past data search unit 6 may he selected by the user to match a feature of the electronic control instrument 1 being a target, or may be an optimum algorithm obtained by the past data search unit 6 through learning.

When the input data and/or internal status data coinciding with or similar to the present input data and/or internal status data is found, the past data search unit 6 sends the found input data and/or internal status data to the condition setting unit 8.

Specific examples of cases where there is not input data and/or internal status data to be set in the simulation performing unit 4 by the condition setting unit 8 include: a case where the past data is data C or data D and the past data does not include the internal status data of the simulation performing unit 4; and a case where the past data is data C or data D and the past data does not sufficiently include the internal status data of the simulation performing unit 4.

The verification device 2

advances to step S06 if the input data and/or internal status data coinciding with or similar to the present input data and/or internal status data is found, and

advances to step S08 otherwise.

(Step S06: Output Process)

The condition setting unit 8

extracts output data which is based on the input data and/or internal status data sent from the past data search unit 6 and which is accumulated in the past data accumulation unit 7, and

instructs the input/output 3 to output the extracted output data.

(Step S07: Interruption Judgment Process)

The simulation performing unit 4 judges whether to interrupt the simulation underway or not. A condition by which the simulation performing unit 4 judges whether to interrupt or not may be arbitrary.

When the simulation performing unit 4 judges to interrupt the simulation underway,

the simulation performing unit 4 typically instructs the input/output unit 3 to output, at a timing within the request response time since an input timing corresponding to a simulation to he interrupted, output data corresponding to a preceding input timing, and

the condition setting unit 8 uses the input data and/or internal status data sent from the past data search unit 6 to set an internal status of the simulation of the simulation performing unit 4.

The verification device 2

advances to step S03 if the simulation performing unit 4 interrupts the simulation underway, and

advances to step S08 otherwise.

(Step S08: Simulation Continuation Process)

The simulation performing unit 4

performs a simulation when the simulation underway is completed, by referring to input data obtained at an input timing subsequent to the input timing corresponding to the completed simulation,

continues a process of this step until the simulation corresponding to the input timing becomes completed within the request response time since the input timing,

typically instructs the input/output unit 3, if the simulation corresponding to the input timing is not completed within the request response time since the input timing, to output, at a timing within the request response time since the input timing, output data corresponding to a latest completed simulation, and

stores input data received from the input/output unit 3 during performing the simulation.

A specific example of a process of this step in a case where the simulation performing unit 4 performs a simulation as illustrated in FIG. 4 will be described.

When the simulation is not completed within the request response time, the input/output unit 3 cannot output to the electronic control instrument 1 output data within the request response time.

In FIG. 4,

simulations corresponding to t₀, t₁, and t₂ are not ended within the request response time,

the simulation performing. unit 4 instructs the input/output unit 3 to output, at d₀, output data corresponding to an input timing that precedes to by one,

the simulation performing unit 4 instructs the input/output unit 3 to output, at d₁, output data corresponding to t₁, and

the simulation performing unit 4 instructs the input/output unit 3 to output, at d₃, output data corresponding to t₂, since a simulation corresponding to t₂ is ended within the request response time,

The simulation performing unit 4 may instruct the input/output unit 3 to output the output data after a simulation corresponding to t₂ is completed and before d₃.

In the example illustrated in FIG. 4, simulations at t₀ to t₂ are not completed within the request response time since the input timing, but the simulation at t₃ is completed within the request response time since the input timing. Therefore, in this example, the simulation performing unit 4 continues the process of step S05 until the simulation at t₃ is completed.

When a simulation is interrupted and internal status data or the like of the simulation is updated to the internal status data or the like saved in the past data accumulation unit 7,

the simulation performing unit 4 concludes that a delay does not occur in a simulation at an input timing corresponding to the interrupted simulation, and

operates at the next input timing and beyond in the same manner as in a case where there is no delay.

When the simulation performing unit 4 is performing a simulation with using past data, if input data from the electronic control instrument 1 deviates from input data being set in the condition setting unit 8,

the past data search unit 6 searches for the past data, and

the condition setting unit 8, from then on, may set output data and an internal status of the simulation of the simulation performing unit 4 with using the past data detected by the past data search unit 6.

The input data from the electronic control instrument 1 deviates from the input data being set in the condition setting unit 8 when, for example, a status of the electronic control instrument 1 changes due to a user operation or the like.

The simulation performing unit 4 may accumulate, in the past data accumulation unit 7, input data of a completed simulation, an internal status of the simulation, and output data of the simulation.

(Step S09: Output Process)

When a simulation underway is completed, the simulation performing unit 4 obtains output data from a simulation result, and sends the output data to the input/output unit 3.

The simulation performing unit 4 may accumulate, in the past data accumulation unit 7, input data of the completed simulation, an internal status of the simulation, and output data of the simulation.

The input/output unit 3 sends the output data received from the simulation performing unit 4 to the electronic control instrument 1.

Feature of Embodiment 1

The verification device 2 according to the present embodiment is provided with:

the simulation performing unit 4 to perform a simulation;

the delay detection unit 5 to detect, as a delay simulation, a simulation being performed by the simulation performing unit 4 and not having real-time responsiveness;

the past data accumulation unit 7 containing an accumulation of past data related to a simulation performed by the simulation performing unit 4 in the past; and

the past data search unit 6 to search for past data corresponding to a delay simulation when the delay detection unit 5 detects the delay simulation.

In the verification device 2 according to the present embodiment, the delay detection unit 5 detects, as the delay simulation, a simulation not likely to be completed within a request response time.

In the verification device 2 according to the present embodiment,

the past data includes input data corresponding to the simulation performed by the simulation performing unit 4 in the past, and

the past data search unit 6 searches for past data including input data coinciding with or similar to input data corresponding to a simulation being performed by the simulation performing unit 4.

In the verification device 2 according to the present embodiment,

the past data includes internal status data expressing an internal status of the simulation performed by the simulation performing unit 4 in the past, and

the past data search unit 6 searches for past data including internal status data coinciding with or similar to the internal status data of a simulation being performed by the simulation performing unit 4.

The verification device 2 according to the present embodiment is provided with

the condition setting unit 8 to set an internal status of a simulation of the simulation performing unit 4 with using internal status data,

wherein when the delay detection unit 5 detects a delay simulation, the condition setting unit 8 sets the internal status of the simulation of the simulation performing unit 4 with using the internal status data included in past data searched for by the past data search unit 6.

In the verification device 2 according to the present embodiment, the simulation performing unit 4 performs a simulation of a control target of the electronic control instrument 1 connected to the verification device 2,

The input/output unit 3 to communicate with the electronic control instrument 1 is provided,

the past data includes input data which corresponds to a simulation performed by the simulation performing unit 4 in the past, and output data which corresponds to a result of a simulation performed on the basis of the input data and which is to be outputted to the electronic control instrument 1,

the past data search unit 6 searches for past data including input data coinciding with or similar to input data corresponding to a simulation being performed by the simulation performing unit 4, and

the input/output unit 3 outputs, when the delay detection unit 5 detects a delay simulation, output data included in the past data searched for by the past data search unit 6 to the electronic control instrument 1.

Description of Effect of Embodiment 1

As described above, according to the present embodiment, a simulation result that is included in past data accumulated in the past data accumulation unit 7 and that is obtained with the proper simulation model is used, so that even in a case where real-time responsiveness cannot be ensured by a proper simulation model, it is possible to output a simulation result that can happen when the proper simulation model is used, while ensuring simulation real-time responsiveness.

<Modification 1>

The verification device 2 may be formed of a plurality of devices,

In the present modification, according to a specific example, the verification device 2 may be formed of a device having the past data accumulation unit 7, and a device having units other than the past data accumulation unit 7 of the verification device 2 of Embodiment 1.

<Modification 2>

The verification device 2 may be software that can run in a computer capable of communicating with the electronic control instrument 1.

<Modification 3>

In step S03, the simulation performing unit 4 may start a plurality of simulations.

In the present modification,

the delay detection unit 5 monitors all simulations being performed by the simulation performing unit 4, and

the verification device 2 executes processes of steps after step S04, per simulation being performed by the simulation performing unit 4.

<Modification 4>

In step S05, if the past data search unit 6 does not find coinciding or similar past data, the verification device 2 may notify it to the user by, for example, displaying on the screen that a simulation delay occurs.

In the present modification, the verification device 2 may be such that the user can confirm the notification from the verification device 2 and can decide whether to continue or interrupt verification carried out by the verification device 2.

<Modification 5>

In step S05, the past data search unit 6 need not necessarily send input data and/or internal status data to the condition setting unit 8.

In the present modification,

the past data search unit 6 may execute the process of step S06 on behalf of the condition setting unit 8, and

in step S07, the condition setting unit 8 does not set input data and/or internal status data of a simulation of the simulation performing unit 4.

<Modification 6>

In step S05, the past data search unit 6 may send past data corresponding to found input data and/or internal status to the condition setting unit 8,

In the present modification, the condition setting unit 8

does not extract output data accumulated in the past data accumulation unit 7, and

instructs the input/output unit 3 to output output data included in the past data received from the past data search unit 6.

<Modification 7>

In step S08, the simulation performing unit 4 may interrupt a simulation underway according to an arbitrary condition.

<Modification 8>

In step S09, while the simulation performing unit 4 is performing a simulation, if the delay detection unit 5 detects a delay, the verification device 2 may advance to step S05.

<Modification 9>

The present embodiment describes a case where the function constituent elements are implemented by software. In a modification, the function constituent elements may be implemented by hardware.

When implementing the function constituent elements by hardware, the verification device 2 is provided with an electronic circuit 17 in place of the processor 11. Alternatively, although not illustrated, the verification device 2 is provided with an electronic circuit 17 in place of the processor 11, the memory 12, and the auxiliary storage device 13. The electronic circuit 17 is a dedicated electronic circuit that implements functions of the function constituent elements (and functions of the memory 12 and auxiliary storage device 13). The electronic circuit may be referred to as processing circuitry as well.

The electronic circuit 17 may be a single circuit, a composite circuit, a programmed processor, a parallel-programmed processor, a logic IC, a Gate Array (GA), an Application Specific Integrated Circuit (ASIC), or a Field-Programmable Gate Array (FPGA).

The function constituent elements may be implemented by one electronic circuit 17, or may be implemented by a plurality of electronic circuits 17 through dispersion.

Alternatively, some of the function constituent elements may be implemented by hardware, and the other function constituent elements may be implemented by software.

The processor 11, memory 12, auxiliary storage device 13, and electronic circuit 17 mentioned before are collectively referred to as “processing circuitry”. That is, the functions of the function constituent elements are implemented by processing circuitry.

### OTHER EMBODIMENTS

Any constituent element of the embodiment described above may be modified. Alternatively, in the embodiment, any constituent element may be omitted.

The embodiment is not limited to Embodiment 1. Various changes may be made to Embodiment 1 as necessary.

### REFERENCE SIGNS LIST

1: electronic control instrument;

2: verification device;

3: input/output unit;

4: simulation performing unit;

5: delay detection unit;

6: past data search unit;

7: past data accumulation unit;

8: condition setting unit;

11: processor;

12: memory;

13: auxiliary storage device;

14: communication IF;

15: HW;

16: SW;

17: electronic circuit;

19: OS.

1. A verification device comprising:
processing circuitry
to perform a simulation;
to detect, as a delay simulation, a simulation being performed and not having real-time responsiveness; and
to search for past data corresponding to a delay simulation when the delay simulation is detected,
the processing circuitry containing an accumulation of past data related to a simulation performed in a past.

2. The verification device according to claim 1,
wherein the processing circuitry detects, as the delay simulation, a simulation not likely to be completed within a request response time.

3. The verification device according to claim 1,
wherein the past data includes input data corresponding to the simulation performed in the past, and
wherein the processing circuitry searches for past data including input data coinciding with or similar to input data corresponding to a simulation being performed.

4. The verification device according to claim 1,
wherein the past data includes internal status data expressing an internal status of the simulation performed in the past, and
wherein the processing circuitry searches for the past data including the internal status data coinciding with or similar to the internal status data of a simulation being performed.

5. The verification device according to claim 4,
wherein the processing circuitry
sets an internal status of a simulation with using the internal status data, and.
when the delay simulation is detected, sets the internal status of the simulation with using the internal status data included in past data searched for.

6. The verification device according to claim 1,
wherein the processing circuitry performs a simulation of a control target of an electronic control instrument connected to the verification device.

7. The verification device according to claim 6,
wherein the processing circuitry communicates with the electronic control instrument,
wherein the past data includes input data which corresponds to a simulation performed in the past, and output data which corresponds to a result of a simulation performed on a basis of the input data and which is to be outputted to the electronic control instrument,
wherein the processing circuitry searches for past data including input data coinciding with or similar to input data corresponding to a simulation being performed, and
wherein the processing circuitry, when a delay simulation is detected, outputs data included in the past data searched for, to the electronic control instrument.

8. A verification method comprising:
performing a simulation;
detecting, as a delay simulation, a simulation being performed and not having real-time responsiveness; and
searching for past data corresponding to a delay simulation when the delay simulation is detected,
wherein past data related to a simulation performed in a past is accumulated.

9. A non-transitory computer-readable recording medium recorded with a verification program which causes a computer containing an accumulation of past data related to a simulation performed in a past,
to perform a simulation;
to detect, as a delay simulation, a simulation being performed by the computer and not having real-time responsiveness; and
to search for past data corresponding to the delay simulation when the computer detects the delay simulation.
